(19) United States
(12) Patent Application Publication
(10) Pub. No.: US 2025/0007061 A1
(43) Pub. Date: Jan. 2, 2025

(54) POWER STORAGE MODULE

(71) Applicant: TOYOTA JIDOSHA KABUSHIKI KAISHA, Toyota-shi (JP)

(72) Inventor: Kenichi KOHASHI, Shizuoka-ken (JP)

(73) Assignee: TOYOTA JIDOSHA KABUSHIKI KAISHA, Toyota-shi (JP)

(21) Appl. No.: 18/675,397

(22) Filed: May 28, 2024

(30) Foreign Application Priority Data
Jun. 27, 2023 (JP) 2023-104684

(51) Int. Cl. H01M 50/242; H01M 10/613; H01M 10/656; H01M 50/209; H01M 50/291; H01M 50/293

(52) U.S. Cl. CPC H01M 50/242; H01M 10/613; H01M 10/656; H01M 50/209; H01M 50/291; H01M 50/293

(57) ABSTRACT

The power storage module includes power storage cells, a resin frame, and a case. The resin frame includes an intervening portion interposed between the pair of power storage cells, and a flow path forming portion forming a flow path of the cooling fluid. The flow path forming portion includes a one-side flow path forming portion provided in a region on one side of the intervening portion in the second direction, and an other-side flow path forming portion provided in a region on the other side of the intervening portion in the second direction. The cross-sectional second moment of the one-side flow path forming portion is larger than the cross-sectional second moment of the other-side flow path forming portion. The spring constant of the other-side flow path forming portion in the first direction is larger than the spring constant of the one-side flow path forming portion in the first direction.

### CROSS-REFERENCE TO RELATED APPLICATION

This application claims priority to Japanese Patent Application No. 2023-104684 filed on Jun. 27, 2023, incorporated herein by reference in its entirety.

### BACKGROUND

### 1. Technical Field

The present disclosure relates to a power storage module.

### 2. Description of Related Art

Japanese Unexamined Patent Application Publication No. 2022-163449 (JP 2022-163449 A), for example, discloses a battery pack including a stack in which a plurality of battery cells and a plurality of resin frames are alternately stacked in an arrangement direction, and a lower case that accommodates the stack. The stack is accommodated in a compressed state in the arrangement direction. The lower case opens upward. The resin frames have a plurality of comb teeth extending in the arrangement direction on at least one of surfaces that face the battery cells. The comb teeth include a plurality of upper comb teeth and a plurality of lower comb teeth. The upper comb teeth are located above the central portion of the battery cells in the height direction. The lower comb teeth are located below the central portion in the height direction. The upper comb teeth are configured such that the height of the comb teeth in the arrangement direction is lower as the upper comb teeth are positioned on the lower side.

### SUMMARY

In the battery pack described in JP 2022-163449 A, there is a concern that the stack is deformed so as to project upward when the geometrical moment of inertia of the upper comb teeth is larger than the geometrical moment of inertia of the lower comb teeth.

An object of the present disclosure is to provide a power storage module capable of suppressing a plurality of power storage cells and a resin frame being deformed so as to project toward an opening side of a case.

An aspect of the present disclosure provides a power storage module including:
a plurality of power storage cells arranged side by side in a first direction;
a resin frame disposed between a pair of power storage cells adjacent to each other, among the power storage cells; and
a case that accommodates the power storage cells and the resin frame while constraining the power storage cells from both sides in the first direction, and that opens toward one side in a second direction orthogonal to the first direction.

The resin frame includes
an intervening portion interposed between the pair of power storage cells, and
a flow path forming portion that is provided on a surface of the intervening portion that faces the power storage cells, and that forms a flow path for a cooling fluid for cooling the power storage cells.

The flow path forming portion includes
a one-side flow path forming portion provided in a region of the intervening portion on the one side in the second direction, and
an other-side flow path forming portion provided in a region of the intervening portion on another side in the second direction.

A geometrical moment of inertia of the one-side flow path forming portion is larger than a geometrical moment of inertia of the other-side flow path forming portion. A spring constant of the other-side flow path forming portion in the first direction is larger than a spring constant of the one-side flow path forming portion in the first direction.

According to the present disclosure, it is possible to provide a power storage module capable of suppressing a plurality of power storage cells and a resin frame being deformed so as to project toward an opening side of a case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a configuration of a power storage module according to an embodiment of the present disclosure;

FIG. 2 is a cross-sectional view taken along II-II line in FIG. 1;

FIG. 3 is a front view of a resin frame;

FIG. 4 is a cross-sectional view taken along IV-IV line in FIG. 3;

FIG. 5 is a cross-sectional view taken along the line V-V in FIG. 3; and

FIG. 6 is a cross-sectional view schematically showing a modification of the resin frame.

### DETAILED DESCRIPTION OF EMBODIMENTS

Embodiments of the present disclosure will be described with reference to the drawings. In the drawings referred to below, the same or corresponding members are denoted by the same reference numerals.

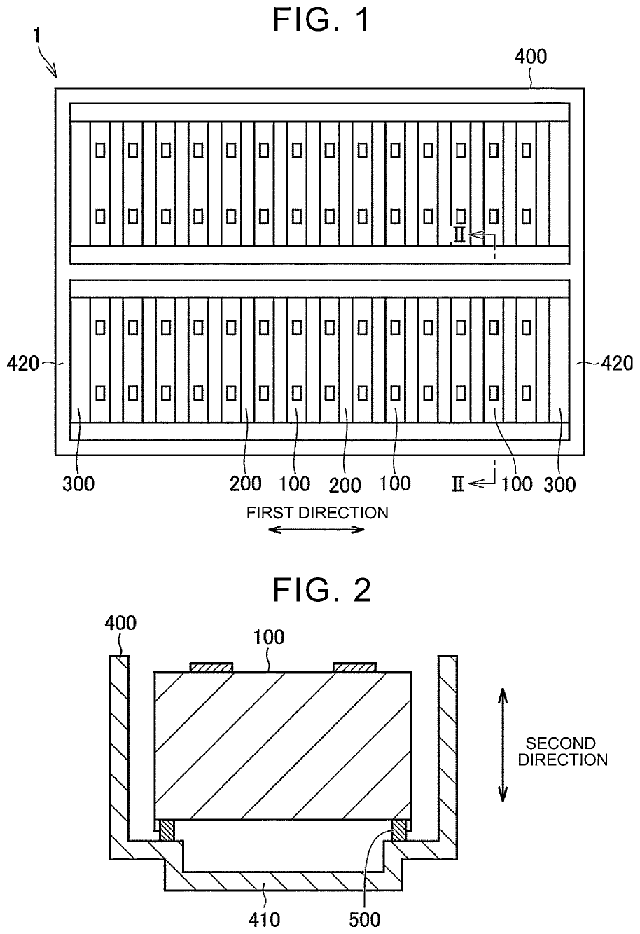

FIG. 1 is a plan view schematically illustrating a configuration of a power storage module according to an embodiment of the present disclosure. FIG. 2 is a cross-sectional view taken along line II-II in FIG. 1. The power storage module 1 is mounted on a vehicle, for example.

As shown in FIG. 1 and in FIG. 2, the power storage module 1 includes a plurality of power storage cells 100, a plurality of resin frames 200, an end plate 300, a case 400, and an elastic member 500.

The plurality of power storage cells 100 are arranged in the first direction (the left-right direction in FIG. 1). Examples of the power storage cell 100 include a lithium ion battery. Each power storage cell 100 is formed in a flat rectangular parallelepiped.

Each resin frame 200 is disposed between a pair of power storage cells 100 adjacent to each other.

The end plates 300 are disposed on both sides of the stack (the plurality of power storage cells 100 and the plurality of resin frames 200) in the first direction.

The case 400 accommodates the plurality of power storage cells 100 and the resin frame 200 while restraining the plurality of power storage cells 100 from both sides in the first direction. The case 400 opens toward one side (the upper side in FIG. 2) in the second direction perpendicular to the first direction. Specifically, the case 400 has a bottom wall 410 (shown in FIG. 2 provided below the stack) and a pair of restraining walls 420 (shown in FIG. 1) arranged on both sides of the stack in the first orientation. Each restraining wall 420 stands from the end of the bottom wall 410 in the first direction. The pair of restraining walls 420 restrain the stack from both sides in the first direction.

The elastic member 500 is disposed between the bottom wall 410 and the stack. The elastic member 500 has a shape that extends long in the first direction. The elastic member 500 is a member for suppressing the coolant (e.g., air) supplied between the stack and the bottom wall 410 passing through the pair of power storage cells 100 in the lateral direction of the stack (the lateral direction in FIG. 2).

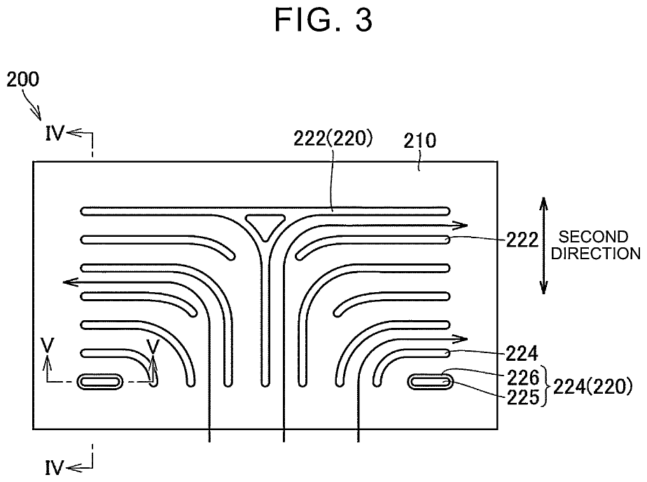

Next, referring to FIG. 3 to FIG. 5, the resin frame 200 will be described. The resin frame 200 includes an intervening portion 210 and a flow path forming portion 220.

The intervening portion 210 is interposed between the pair of power storage cells 100. The intervening portion 210 has a function of securing insulation between the pair of power storage cells 100 adjacent to each other. The intervening portion 210 is made of, for example, PP or PE.

The flow path forming portion 220 is provided on a surface of the intervening portion 210 facing the power storage cell 100. The flow path forming portion 220 forms a flow path of a cooling fluid (fluid supplied between the bottom wall 410 and the stack) for cooling the power storage cell 100. As indicated by arrows in of FIG. 3, the flow path forming portion 220 is formed to guide the coolant supplied from below the intervening portion 210 upward toward the side of the intervening portion 210 (a direction perpendicular to both the first direction and the second direction). The flow direction of the cooling fluid may be opposite to the direction of the arrow. The flow path forming portion 220 includes a one-side flow path forming portion 222 and an other-side flow path forming portion 224.

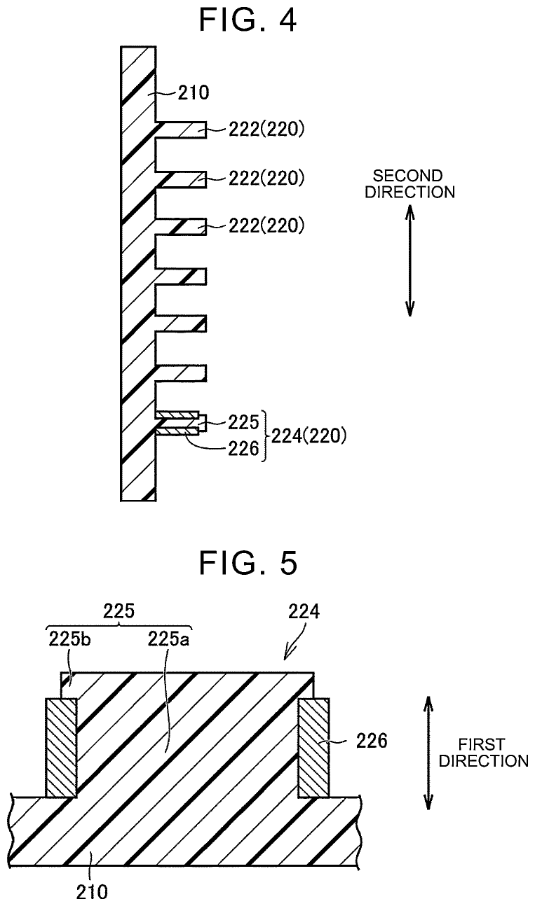

The one-side flow path forming portion 222 is provided in a region of the intervening portion 210 on the one side (the side on which the case 400 opens) in the second direction. As shown in FIG. 4, the one-side flow path forming portion 222 is formed integrally with the intervening portion 210 with the same material as the material forming the intervening portion 210.

The other-side flow path forming portion 224 is provided in a region of the intervening portion 210 on the other side in the second direction (the bottom wall 410 side in the present embodiment).

The shape of the flow path forming portion 220 is set so that the secondary moment of the section of the one-side flow path forming portion 222 is greater than the secondary moment of the section of the other side flow path forming section 224. In the present embodiment, as shown in FIG. 3, the volume of the portion that extends continuously in the width direction (the direction perpendicular to both the first direction and the second direction) in the one-side flow path forming portion 222 is larger than the volume of the portion that extends continuously in the width direction in the other-side flow path forming portion 224.

The spring constant of the other-side flow path forming portion 224 in the first direction is larger than the spring constant of the one-side flow path forming portion 222 in the first direction. In the present embodiment, the other-side flow path forming portion 224 includes an upright portion 225 and a surrounding portion 226.

The upright portion 225 is upright from the intervening portion 210. The upright portion 225 is formed integrally with the intervening portion 210 of the same material as the material forming the intervening portion 210.

The surrounding portion 226 surrounds the upright portion 225. A protruding dimension of the surrounding portion 226 from the intervening portion 210 is smaller than a protruding dimension of the upright portion 225 from the intervening portion 210. In other words, the upright portion 225 protrudes from the surrounding portion 226.

In the present embodiment, the surrounding portion 226 is formed separately from the upright portion 225. As shown in of FIG. 5, the upright portion 225 includes a holding portion 225a that holds the surrounding portion 226, and a sandwiching portion 225b provided at a distal end of the holding portion 225a. The holding portion 225a is connected to the intervening portion 210. The sandwiching portion 225b sandwiches the surrounding portion 226 together with the intervening portion 210. That is, the sandwiching portion 225b has a function of preventing the surrounding portion 226 from being detached from the holding portion 225a.

The surrounding portion 226 has a flexural rigidity higher than the compressive elastic modulus of the upright portion 225 in the first direction. The surrounding portion 226 is made of, for example, metallic material or fiber-reinforced plastic (FRP).

As described above, in the power storage module 1 of the present embodiment, the cross-sectional secondary moment of the one-side flow path forming portion 222 is larger than the cross-sectional secondary moment of the other-side flow path forming portion 224. The spring constant of the other-side flow path forming portion 224 in the first direction is larger than the spring constant of the one-side flow path forming portion 222 in the first direction. Therefore, the stack (the plurality of power storage cells 100 and the resin frame 200) is prevented from being deformed so as to be convex toward one side (the side where the case 400 is opened) in the second direction.

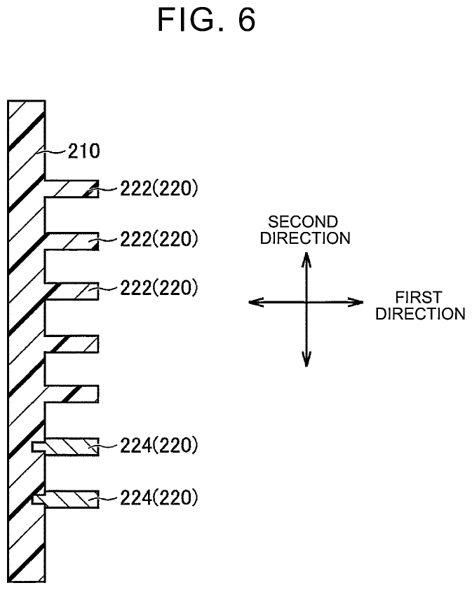

As shown in FIG. 6, the other-side flow path forming portion 224 may be formed of a material (e.g., PPS, PEEK, fiber-reinforced PP/PE, stainless-steel, steel, aluminum) that differs from the material forming the intervening portion 210 and the one-side flow path forming portion 222. In this case, the resin frame 200 may be formed by two-color molding. In the other-side flow path forming portion 224, the other-side flow path forming portion 224 may be connected to the intervening portion 210. Alternatively, although not shown, the one-side flow path forming portion 222 may be formed of a material (for example, PPS, PEEK, fiber-reinforced PP/PE, stainless-steel, steel, or aluminum) that differs from the material forming the intervening portion 210 and the other-side flow path forming portion 224. In either case, the material of the one-side flow path forming portion 222 and the material of the other-side flow path forming portion 224 are selected so that the spring constant of the other-side flow path forming portion 224 in the first direction is larger than the spring constant of the one-side flow path forming portion 222 in the first direction.

It will be understood by those skilled in the art that the exemplary embodiments described above are illustrative of the following aspects.

### First Aspect

A plurality of power storage cells arranged side by side in a first direction; A resin frame disposed between a pair of power storage cells adjacent to each other among the plurality of power storage cells;

A case accommodating the plurality of power storage cells and the resin frame while constraining the plurality of power storage cells from both sides in the first direction, and opening toward one side in a second direction orthogonal to the first direction,

The resin frame,

An intervening portion interposed between the pair of power storage cells,

A flow path forming portion is provided on a surface of the intervening portion facing the power storage cell, and forms a flow path of a cooling fluid for cooling the power storage cell,

The flow path forming portion,

The one-side flow path forming portion provided in the region on the one side in the second direction of the intervening portion,

The other-side flow path forming portion provided in the region on the other side in the second direction of the intervening portion,

The second moment of the section of the one-side flow path forming portion is larger than the second moment of the section of the other-side flow path forming portion.

A power storage module, wherein a spring constant of the other-side flow path forming portion in the first direction is larger than a spring constant of the one-side flow path forming portion in the first direction.

In this power storage module, the secondary moment of the cross section of one-side flow path forming portion is larger than the secondary moment of the cross section of the other-side flow path forming portion. The spring constant of the other-side flow path forming portion in the first direction is larger than the spring constant of the one-side flow path forming portion in the first direction. Therefore, the plurality of cells and the resin frame are prevented from being deformed so as to be convex toward one side (the side where the case is opened) in the second direction.

### Second Aspect

The other-side flow path forming portion,

An upright portion standing from the intervening portion,

A surrounding portion surrounding the upright portion,

The power storage module according to aspect 1, wherein the upright portion protrudes from the surrounding portion.

In this aspect, the surrounding portion restricts the upright portion from attempting to expand in a direction orthogonal to the first direction due to the upright portion being subjected to a compressive load in the first direction. Therefore, the spring constant of the other-side flow path forming portion is larger than the spring constant of the one-side flow path forming portion.

### Third Aspect

The power storage module according to aspect 2, wherein the surrounding portion is formed separately from the upright portion.

In this aspect, it is possible to easily adjust the spring constant of the other-side flow path forming portion by adjusting the thickness and the material of the surrounding portion.

### Fourth Aspect

The power storage module according to aspect 3, wherein the surrounding portion has a flexural rigidity higher than a compressive elastic modulus of the upright portion.

### Fifth Aspect

The upright portion,

A holding portion for holding the surrounding portion,

The power storage module according to aspect 3 or aspect 4, further comprising: a holding portion provided at a distal end of the holding portion and holding the surrounding portion together with the intervening portion.

In this aspect, detachment of the surrounding portion from the upright portion is suppressed.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage module comprising:
a plurality of power storage cells arranged side by side in a first direction;
a resin frame disposed between a pair of power storage cells adjacent to each other, among the power storage cells; and
a case that accommodates the power storage cells and the resin frame while constraining the power storage cells from both sides in the first direction, and that opens toward one side in a second direction orthogonal to the first direction, wherein:
the resin frame includes
an intervening portion interposed between the pair of power storage cells, and
a flow path forming portion that is provided on a surface of the intervening portion that faces the power storage cells, and that forms a flow path for a cooling fluid for cooling the power storage cells;
the flow path forming portion includes
a one-side flow path forming portion provided in a region of the intervening portion on the one side in the second direction, and
an other-side flow path forming portion provided in a region of the intervening portion on another side in the second direction;
a geometrical moment of inertia of the one-side flow path forming portion is larger than a geometrical moment of inertia of the other-side flow path forming portion; and
a spring constant of the other-side flow path forming portion in the first direction is larger than a spring constant of the one-side flow path forming portion in the first direction.

2. The power storage module according to claim 1, wherein:
the other-side flow path forming portion includes
an upright portion that stands upright from the intervening portion, and
a surrounding portion that surrounds the upright portion; and
the upright portion projects from the surrounding portion.

3. The power storage module according to claim 2, wherein the surrounding portion is formed separately from the upright portion.

4. The power storage module according to claim 3, wherein the surrounding portion has a flexural rigidity higher than a compressive elastic modulus of the upright portion.

5. The power storage module according to claim 3, wherein the upright portion includes
a holding portion that holds the surrounding portion, and
a sandwiching portion that is provided at a distal end of the holding portion, and that sandwiches the surrounding portion together with the intervening portion.
